(19) United States
(12) Patent Application Publication
(10) Pub. No.: US 2013/0019230 A1
(43) Pub. Date: Jan. 17, 2013

(54) Program Generating Apparatus, Method of Generating Program, and Medium

(71) Applicants: Yu Nakanishi, Kanagawa (JP); Toshiki Kizu, Kanagawa (JP); Shunsuke Sasaki, Tokyo (JP); Takahiro Tokuyoshi, Kanagawa (JP)

(72) Inventors: Yu Nakanishi, Kanagawa (JP); Toshiki Kizu, Kanagawa (JP); Shunsuke Sasaki, Tokyo (JP); Takahiro Tokuyoshi, Kanagawa (JP)

(73) Assignee: Kabushiki Kaisha Toshiba, Tokyo (JP)

(21) Appl. No.: 13/423,641

(22) Filed: Mar. 19, 2012

(30) Foreign Application Priority Data
Jul. 15, 2011 (JP) 2011-157111

(51) Int. Cl. G06F 9/45

(52) U.S. Cl. 717/149

(57) ABSTRACT

According to an embodiment, a program generating apparatus includes a cross-compiling unit, a processing time calculating unit, a source code converting unit, and a self-compiling unit. The cross-compiling unit generates sin instruction string for each basic block based on a source code and specifies instructions performing a memory access. The processing time calculating unit calculates a processing time of the instruction string for each basic block. The source code converting unit inserts a first code, which adds the processing time of the basic block to an accumulated processing time variable of an executed thread of the basic block, and a second code, which calculates the processing time for the specified memory access and adds the calculated processing time to the accumulated processing time variable, into the source code. The self-compiling unit generates a performance estimating program outputting the accumulated processing time variable of the thread executed.

### CROSS-REFERENCE TO RELATED APPLICATIONS

This application is based upon and claims the benefit of priority from Japanese Patent Application No. 2011-157111, filed on Jul. 15, 2011; the entire contents of which are incorporated herein by reference.

### FIELD

Embodiments described herein relate generally to a program generating apparatus, a method of generating a program, and a medium.

### BACKGROUND

Recently, multiprocessors each having a memory group in which a plurality of memories is configured to be hierarchically connected have been developed. In a cage where software is produced in a cross development environment for the multiprocessor as a target processor, an operation of estimating the performance acquired when the produced software is executed by the target processor is necessary. Here, the performance represents a processing time required for the execution.

### BRIEF DESCRIPTION OF THE DRAWINGS

FIG. 1 is a diagram illustrating a configuration example of a target machine according to a first embodiment;

FIG. 2 is a conceptual diagram illustrating the appearance of calculating an estimation of the processing time of the target machine illustrated in FIG. 1;

FIG. 3 is a diagram illustrating the configuration of a memory model corresponding to the target machine illustrated in FIG. 1;

FIG. 4 is a diagram illustrating a hardware configuration example of a host machine;

FIG. 5 is a diagram illustrating the functional configuration of a generator;

FIG. 6 is a flowchart illustrating an operation until an estimation value is acquired after a user inputs an input source code to the generator;

PIG. 7 is a diagram illustrating a specific example of the input source code;

FIG. 8 is a diagram illustrating a control flow corresponding to the input source code illustrated in FIG. 7;

FIG. 9 is a diagram illustrating a specific example of an analysis preliminary information-added source code;

FIG. 10 is a diagram illustrating a specific example of target processor instruction preliminary information;

FIG. 11 is a diagram illustrating the characteristics of memories that are included in a target processor;

FIG. 12 is a flowchart illustrating the appearance of determining a memory of an access destination;

FIG. 13 is a diagram illustrating a specific example of the target processor instruction executing information according to the first embodiment;

FIG. 14 is a diagram illustrating a specific example of a source code with analysis API;

FIG. 15 is a diagram illustrating a specific example of a first target instruction executing analyzing process;

FIG. 16 is a diagram illustrating a specific example of a second target instruction executing analyzing process;

FIG. 17 is a flowchart illustrating an operation of the second target instruction executing analyzing process;

FIG. 18 is a flowchart illustrating an operation of a memory model when an effect investigating request is received;

FIG. 19 is a diagram illustrating a reuse distance model;

FIG. 20 is a flowchart illustrating thread scheduling;

FIG. 21 is a flowchart illustrating an operation of the memory model when a memory access request is received;

FIG. 22 is a diagram illustrating another example of calculating the processing time required for a memory access;

FIG. 23 is a diagram illustrating a configuration example of a target machine according to a second embodiment;

FIG. 24 is a conceptual diagram illustrating the appearance of calculating the processing time of the target machine illustrated in FIG. 23;

FIG. 25 is a diagram illustrating a specific example of an input source code according to the second embodiment;

FIG. 26 is a diagram illustrating a specific example of an analysis preliminary information-added source code according to the second embodiment;

FIG. 27 is a diagram illustrating a specific example of target processor instruction preliminary information according to the second embodiment;

FIG. 28 is a diagram illustrating a specific example of target processor instruction executing information according to the second embodiment;

FIG. 29 is a diagram illustrating a specific example of a source code with analysis API according to the second embodiment;

FIG. 30 is a diagram illustrating a specific example of a third target instruction executing analyzing process;

FIG. 31 is a diagram illustrating a specific example of an external hardware model executing process according to the second embodiment;

FIG. 32 is a diagram illustrating a specific example of an target machine according to a third embodiment; and

FIG. 33 is a diagram illustrating a specific example of an external hardware model executing process according to the third embodiment.

### DETAILED DESCRIPTION

In general, according to an embodiment, a program generating apparatus includes a cross-compiling unit, a processing time calculating unit, a source code converting unit, and a self-compiling unit. The cross-compiling unit generates an instruction string for each basic block based on a source code and specifies instructions, which are included in the instruction string, performing a memory access. The processing time calculating unit calculates a processing time of the instruction string for each basic block and generates a memory access information, which is used for identifying an access destination of the memory access, for each of the specified instructions. The source code converting unit inserts a first code, which adds the processing time of the basic block to an accumulated processing time variable of an executed thread of the basic block, and a second code, which calculates the processing time required for the memory access based on the memory access information and adds the calculated processing time to the accumulated processing time variable of an executed thread of the memory access, into the source code. The self-compiling unit generates a performance estimating program outputting the accumulated processing time variable of the thread executed last time based on the source code after the insertion of the codes.

Exemplary embodiments of a program generating apparatus, a method of generating a program, and a medium will be explained below in detail with reference to the accompanying drawings. The present invention is not limited to the following embodiments.

A first embodiment of the invention is a program generating apparatus that can acquire an estimation of the processing time required for a case where software is executed on a target machine in an environment in which the target machine is not present.

Here, a target machine is assumed to have a multiprocessor architecture in which a plurality of processors is connected to a memory group having a hierarchical configuration. In addition, a memory is a device that maintains digital data processed by a processor. The processor included in the target machine is a calculation device that performs intrinsic Instructions and will be referred to as a target processor. In addition, a device that includes a processor other than the target processor, a memory, an input/output device, and the like and generates a program (performance estimating program) used for estimating the performance of a program for the target machine or acquires a processing time by executing the generated performance estimating program will be referred to as a host machine, and a calculation device included in the host machine will be referred to as a host processor.

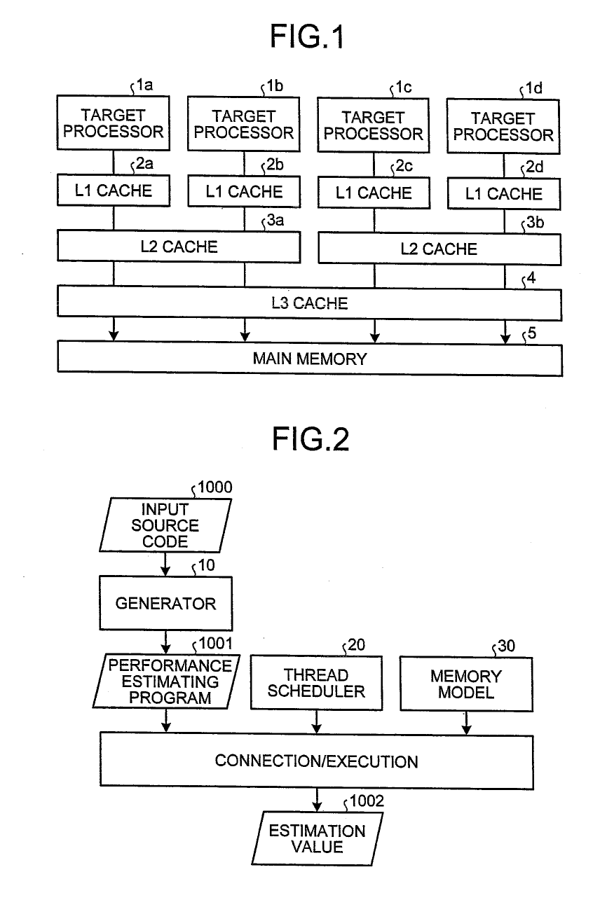

FIG. 1 is a diagram illustrating a configuration example of the target machine. The target machine illustrated in FIG. 1 includes four target processors 1a to 1d and one main memory 5. Here, cache memories (L1 caches 2a to 2d) are respectively connected to the target processors 1a to 1d. In addition, the L1 caches 2a and 2b are connected to an L2 cache 3a together, and the L1 caches; 2c and 2d are connected to an L2 cache 3b together. Furthermore, L2 caches 3a and 3b are connected to an L3 cache 4, and the L3 cache 4 is connected to the main memory 5.

Hereinafter, each one of the L1 caches 2a to 2d, the L2 caches 3a and 3b, the L3 cache 4, and the main memory 5 that are included in the target machine will be referred to as an individual memory, and a memory system formed by connecting the L1 caches 2a to 2d, the L2 caches 3a and 3b, the L3 cache 4, and the main memory 5 will be referred to as a memory group.

In addition, it is assumed that the source code of software can be converted into a machine instruction string without any loss in the meaning by using a compiler as a conversion device. The converted machine instruction string will be referred to as a program. In addition, to compile a source code into a host machine-dedicated program will be referred to as self-compiling, and to compile a source code into a target machine-dedicated program will be referred to as cross-compiling. A program generated by self-compiling will be referred to as a host program, and a program generated by cross-compiling will be referred to as a target machine program. In addition, the complied software includes an instruction string that is executable on the target processor, and this instruction string will be referred to as a thread. The program is a set of the threads. Here, software having parallelism represents software in which a program generated through compiling has threads that can be simultaneously executed by mutually different processors, and the threads operate in cooperation with each other.

FIG. 2 is a conceptual diagram illustrating the appearance of calculating an estimation of the processing time of the target machine illustrated in FIG. 1.

As Illustrated in FIG. 2, an input source code 1000 of software that is desired to be executed on the target machine is input to a generator (program generating apparatus) 10. The generator 10 analyzes an instruction to be executed on a target processor based on the input source code 1000 and generates a performance estimating program 1001 by adding an instruction for accessing a memory model 30 or a thread scheduler 20 to the input source code 1000 based on the analysis result. The instruction added to this input source code 1000 is a host machine-dedicated instruction, and the performance estimating program 1001 is a host program. The performance estimating program 1001 is executed by a host machine that includes the scheduler 20 and the memory model 30 and generates and outputs an estimation value 1002.

In addition, in the first embodiment, although the input source code 1000 is assumed to be data that is described in a high-level language, the input source code 1000 may be data described in any way as long as it can be converted into a machine instruction string without any loss in the meaning by using the compiler.

The thread scheduler 20 has a function of managing an accumulated processing time kept by each thread. The accumulated processing time kept by the thread is a sum of processing times required for the execution of an instruction on the target machine. In addition, the thread scheduler 20 has a function of receiving an inquiry on whether the currently executed thread can execute a process affecting the other threads and permitting the execution when the process can be executed or temporarily stopping the thread until the process can be executed when the process cannot be executed. Accordingly, the occurrence of a contradiction that a future process affects the past when the thread is executed on the target machine can be prevented.

In a case where an instruction for an access to the memory model 30 is executed, the memory model 30 has a function of receiving the memory access information as an input, returning another thread affected by the access, and retuning a processing time required for the access. Here, the memory model 30 is acquired by modeling the memory group included in the target machine. Digital data transmitted to the memory group is maintained at a unique place in accordance with positional information (address). The memory access information is information that includes an access symbol, an access size, and an access type. The access type is either Read or Write. The access symbol represents a symbol that represents a variable in the source code.

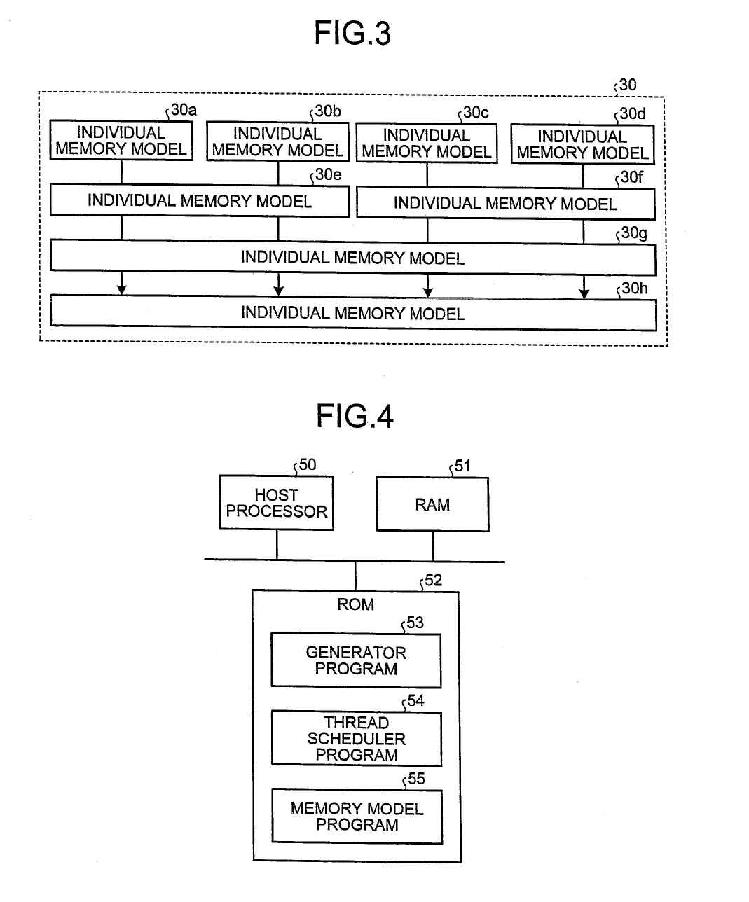

FIG. 3 is a diagram illustrating the configuration of the memory model 30 corresponding, to the memory group that is included in the target machine illustrated in FIG. 1. The memory model 30 is configured by individual memory models 30a to 30h. The individual memory models 30a, 30b, 30c, and 30d correspond to the L1 caches 2a, 2b, 2c, and 2d, and the individual memory models 30e and 30f correspond to the L2 caches 3a and 3b. The individual memory model 30g corresponds to the L3 cache 4, and the individual memory model 30h corresponds to the main memory 5. Each one of the individual memory models 30a to 30g maintains information used for specifying a connection destination (an individual memory model and a target processor).

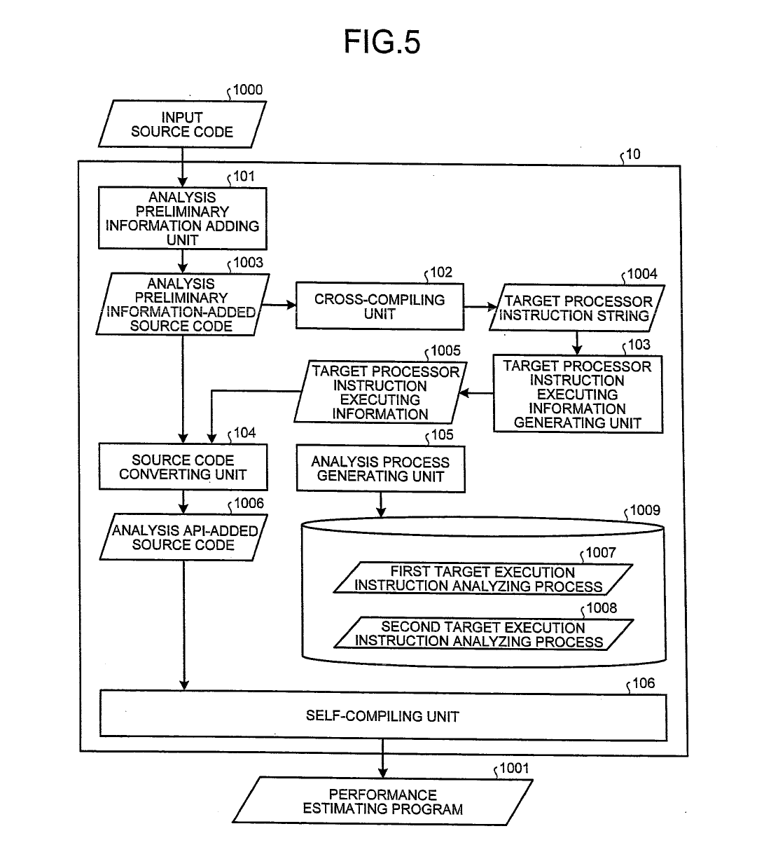

FIG. 4 is a diagram illustrating a hardware configuration example of the host machine. The host machine includes a host processor 50, random access memory (RAM) 51, and read only memory (ROM) 52. In the ROM 52, a generator program 53, a thread scheduler program 54, and a memory model program 55 are stored.

As the generator program 53 stored in the ROM 52 is loaded into a program storing area of the RAM 51 and is executed by the host processor 50, whereby the host machine realizes the function of the generator 10, The input source code 1000, for example, is input from an external storage device that is not illustrated in the figure. The host processor 50 processes the input source code 1000 in accordance with the generator program 53 loaded into the RAM 51 and outputs the performance estimating program 1001. The output destination of the performance estimating program 1001 may be the RAM 51 or an external storage device.

The thread scheduler program 54 and the memory model program 55 loaded in the ROM 52 are loaded into the program storing area of the RAM 51. Through execution by using the host processor 50, the host machine realises the functions of the thread scheduler 20 and the memory model 30. In the state in which the thread scheduler program 54 and the memory model program 55 are loaded in the RAM 51, the performance estimating program 1001 is loaded into the program storing area of the RAM 51 and is executed by the host processor 50. When an instruction for calling the function of the thread scheduler 20, which is included in the performance estimating program 1001, is executed, the host processor 50 moves the control to the thread scheduler program 54. In addition, an instruction for calling the function of the memory model 30 is executed, the host processor 50 moves the control to the memory model program 55.

In addition, the host machine realizing the generator 10 and the host machine realizing the environment in which the performance estimating program 1001 is executed may be different from each other.

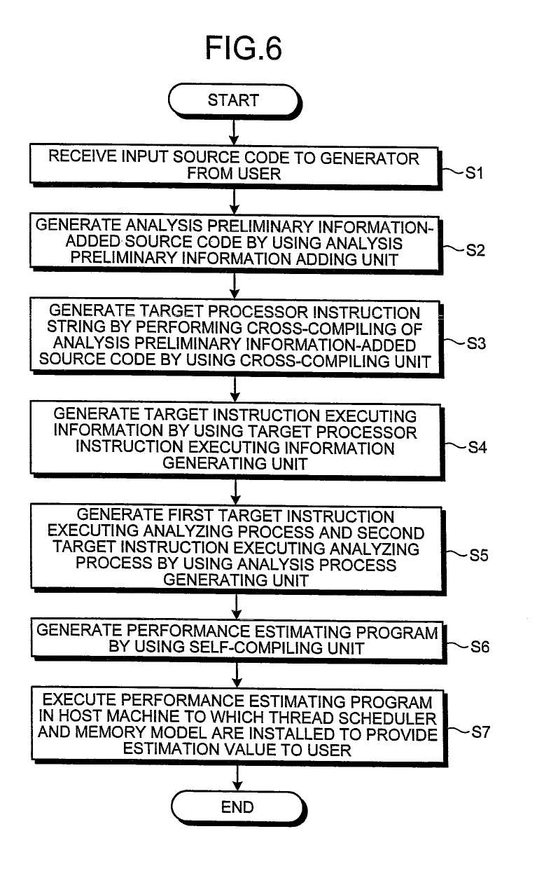

FIG. 5 is a diagram illustrating the functional configuration of the generator 10, and FIG. 6 is a flowchart illustrating an operation until an estimation value 1002 is calculated after an input source code 1000 is input to the generator 10.

The generator 10 includes an analysis preliminary information adding unit 101, a cross-compiling unit 102, a target processor instruction executing information generating unit (processing time calculating unit) 103, a source code converting unit 104, an analysis process generating unit 105, and a self-compiling unit 106. The functions and the operations of such constituent elements will be described in detail with reference to FIGS. 5 and 6,

First, an input source code 1000 is input to the generator 10 in step S1.

The analysis preliminary information adding unit 101 generates an analysis preliminary information-added source code 1003 by inserting analysis preliminary information into the input source code 1000 in step S2. The analysis preliminary information is information that is used for classifying a code row group configuring the input source code 1000 for each basic block and specifying a code row that performs a process affecting the outside of the target processors, 1a

to 1d. In the first embodiment, a memory access corresponds to the process affecting the outside of the target processors 1a to 1d. Hereinafter, out of the analysis preliminary information, analysis preliminary information used for classifying the code row group for each basic block and analysis preliminary information used for specifying the code row that performs a process affecting the outside of the target processors 1a to 1d may be distinguishably represented as first analysis preliminary information and second analysis preliminary information.

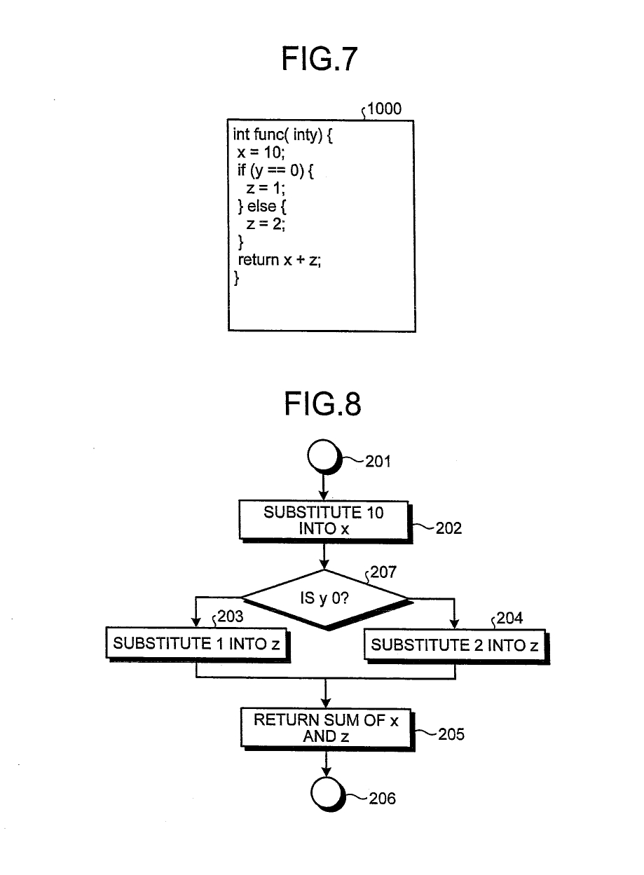

FIG. 7 is a diagram illustrating a specific example of the input source code 1000, and FIG. 8 is a diagram illustrating a control flow corresponding to the input source Code 1000 illustrated in FIG. 7. The control flow represents the flow of the process represented by the source code, and a basic block represents a minimal processing unit that is handled in the control flow. In order to convert the input source code 1000 into a program without any loss in the meaning by using the compiler, the basic block is performed in the same control flow regardless of whether it is performed in any of the target machine and the host machine. In the control flow illustrated in FIG. 8, processes 201 to 207 correspond to a basic block. The branching process 207 includes information that represents a proceeding process out of the processes (processes 203 and 204) of branched destinations.

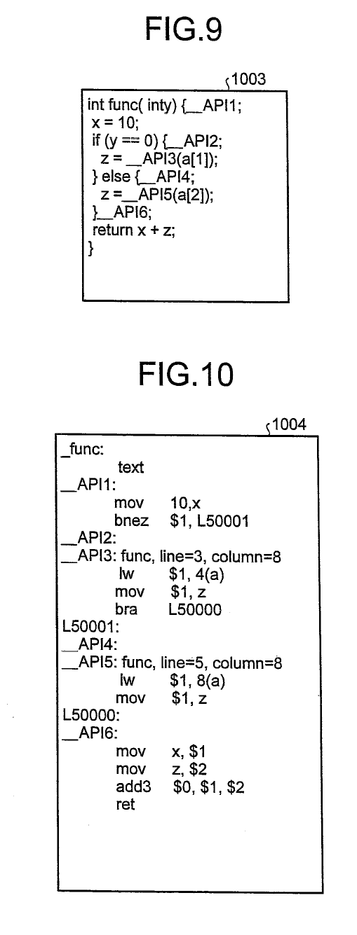

FIG. 9 is a diagram illustrating a specific example of the analysis preliminary information-added source code 1003. Here, the analysis preliminary information is assumed to be a description calling a functional type application programming interface (API).

In the analysis preliminary information-added source code 1003 illustrated in FIG. 9, _API1, _API2, _API4, and _API6 correspond to the first analysis preliminary information. When the analysis preliminary information-added source code 1003 is complied, and the program is executed, for example, in a case where the control flow is configured to flow through the process 203, _API1, _API2, and _API6 that are located in the beginning of the basic block are executed. In a case where _API1, _API2, and _API6 are executed on the host machine, a user can understand that the basic block is processed in a control flow passing through the process 203 also on the target, machine.

In addition, _API3, and _API5 correspond to the second analysis preliminary information. Here, “z=a[1]” represents that information positioned at an address acquired by adding one unit address to an addressed represented by symbol a is read, and z is substituted with the read value. In addition, one unit address is a data size allocated to the symbol.

Next, the cross-compiling unit 102 performs cross-compiling of the analysis preliminary information-added source Code 1003 and outputs a target processor instruction string 1004 that is an instruction string for a target machine in step S3. Here, the cross-compiling unit 102 classifies and generates an instruction string for a target machine for each basic block and specifies an instruction, which is included in the above-described generated instruction string, for performing a memory access. More specifically, when the analysis preliminary information-added source code 1003 is sequentially converted into an instruction string, the cross-compiling unit 102 generates a description that represents the beginning of a basic block from the code row including the first analysis preliminary information and generates a description specifying an instruction for performing a memory access from a code row including the second analysis information.

FIG. 10 is a diagram illustrating a specific example of the target processor instruction string 1004. As illustrated in the figure, the target processor instruction string 1004 has a configuration in which descriptions of “_API1:”, “_API2:”, “_API3: func, line=3, column=8”, “_API4:”, “_API5: func, line=5, column=8” and “_API6:” are inserted into an instruction string acquired by performing cross-compiling of an input source code 1000.

Out of such descriptions, the descriptions of “_API1:”, “_API2:”, “_API4:”, and “_API6:” are generated in correspondence with the first analysis preliminary information and are generated at the beginning of each basic block that configures the instruction string acquired by performing cross-compiling the input source code 1000, According to insertion positions of the descriptions generated in correspondence with the first analysis preliminary information, the instruction string acquired by performing cross-compiling the input source code 1000 is classified into four basic blocks. In other words, in a basic block represented by _API1, it can be understood that a mov instruction and a bnez instruction are executed. Similarly, it can be understood that lw, mov, and bra instructions are executed in a basic block represented by _API2, lw and mov instructions are executed in a basic block represented by _API4, two mov instructions and add3 and ret instructions are. executed in a basic block represented by _API6.

Here, the mov instruction is an instruction for substituting the value of the second argument into the first argument, and the add3 instruction is an instruction for substituting a sum of values of the second and third arguments into the first argument. In addition, the bnez instruction is an instruction for jumping to the label of the second argument unless the value of the first argument is zero, and the bra instruction is an instruction for unconditionally jumping to the label of a designated destination. Furthermore, the lw instruction is an instruction accompanying a memory access and is an instruction for reading 4 byte data from a corresponding address and substituting the read data into a register. In arguments, a symbol row starting from “$” represents a register, a symbol row starting from a number represents a numeric value, and a symbol row starting from an alphabet represents a variable. Hereinafter, the descriptions generated in correspondence with the first analysis preliminary information may be referred to as basic block specifying information.

In addition, the basic block represented by _API3 and _API5 include the lw instructions that accompany memory accesses. The descriptions of “_API3: func, line=3, column=8” and “_API5: func, line=5, column =8” are generated in correspondence with the second analysis preliminary information and are generated in such basic blocks including instructions for performing memory accesses. Such a description includes a description that specifies the position at which the instruction accompanying the memory access is executed in the input source code 1000, Hereinafter, the description generated in correspondence with the second analysis preliminary information may be referred to as memory access instruction specifying information.

Next, a target processor instruction executing information generating unit 103 generates target processor instruction executing information 1005 based on the target processor instruction string 1004 in step S4. The target processor instruction executing information 1005 is configured by a processing time required for the execution of a target processor instruction and the memory access information.

The target processor instruction executing information generating unit 103 calculates a processing time required for the execution of a target processor instruction based on the control flow and the basic block. The target processor instruction executing information generating unit 103 can recognize an instruction that is executed when the basic block is processed based on the basic block specifying information that is inserted into the target processor instruction string 1004. The processing time of an instruction that does not accompanying a memory access is predetermined. Accordingly, when instructions to be executed and the number of the instructions are given, the target processor instruction executing information generating unit 103 can calculate a processing time required for the execution by using the target processor.

On the other hand, the processing time required for an instruction accompanying a memory access is acquired by adding a processing time depending on the individual memory model of the access destination to the processing time of the instruction. The target processor instruction executing information generating unit 103 inserts memory access information into a place at which the processing time required for an instruction accompanying a memory access is described. The target processor instruction executing information generating unit 103 can recognize whether or not an instruction accompanying a memory access is included in the basic block by referring to the memory access specifying information. In addition, the memory access information is information used for identifying the access destination of the memory access and includes an access symbol, an access size, and an access type, in the memory access information, the processing time that depends on the individual memory model of the access destination is not included.

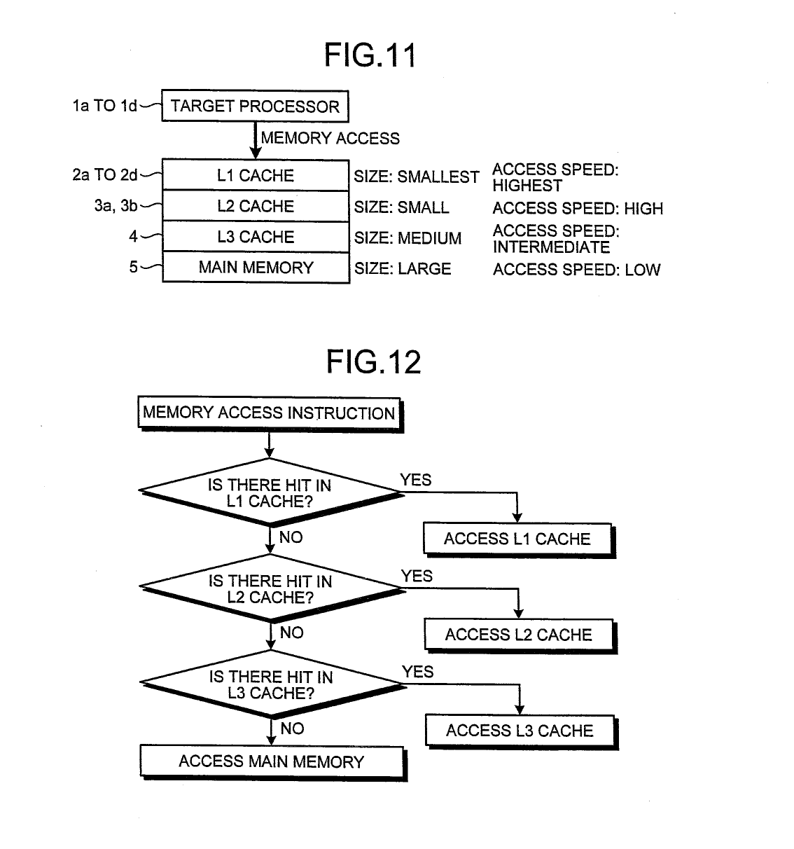

FIG. 11 is a diagram illustrating the characteristics of individual memories that are included in the target processor, and FIG. 12 is a flowchart illustrating the appearance of determining an individual memory of an access destination. As illustrated in FIG. 11, in the order of the L1 caches 2a to 2d, the L2 caches 3a and 3b, the L3 cache 4, and the main memory 5, while the memory size is increased, the access speed is decreased. As illustrated in FIG. 12, in a case where the access destinations of the target processors 1a to 1d do not hit the cache on the side of the target processors 1a to 1d, the caches located on the main memory 5 side are searched, and, in a case where there is no hit in the cache located on any side, the main memory 5 is accessed. While the access speed for the cache is higher toward the side of the target processors 1a to 1d and is lower toward the side of the main memory 5, it is unknown that which hierarchy of the individual memory is the access destination, and accordingly, the processing time required for an instruction accompanying a memory access cannot be estimated by the target processor instruction executing information generating unit 103.

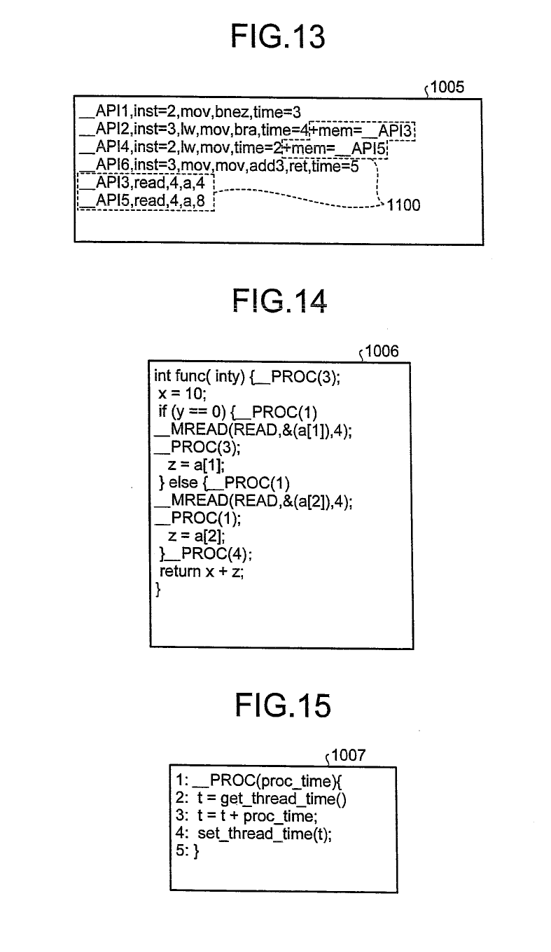

FIG. 13 is a diagram illustrating a specific example of the target processor instruction executing information 1005. The first row of the target processor instruction executing information 1005 represents that two instructions are executed by the target machine when the basic block represented by _API1 is processed, and it takes three cycles for the process. The reason for this is that it takes one cycle for the mov instruction, and it takes two cycles for the bnez instruction. In addition, as illustrated in the second row, in a case where a memory access is accompanied within an instruction as _API2, the processing time is acquired by adding a time required for accessing a memory model to a time required for processing the instruction. Here, since the processing time required for the memory access is unknown to the target processor instruction executing information generating unit 103, the memory access information is output instead of the time required for an access to the memory model. The description 1100 illustrated in FIG. 13 is the memory access information. The memory access information illustrated in FIG. 13 illustrates that a memory access represented by _API3 is performed in a basic block represented by _API2, and a memory access represented by _API5 is performed in a basic block represented by _API4. In addition, in the memory access information, as illustrated in the fifth and sixth rows of the target processor instruction executing information 1005, the access symbol, the access size, and the access type of each memory access for _API3 and _API5 are described. For example, in the fifth row, “read” represents the access type, “4” described next represents the access size, and “a” further described next represents the symbol information on the input source code 1000, and “4” further described next represents an offset from the address represented by the symbol. In other words, the memory access represented by _{—API}3 represented in the fifth row represents a memory access for reading four byte data from the address acquired by adding four to the address represented by the symbol a.

As above, the target processor instruction executing information generating unit 103 calculates a processing time required for a process not affecting the outside of the target processors 1a to 1d, in other words, the process executed within the target processors 1a to 1d for each basic block based on the instruction string for each basic block and generates memory access information used for identifying the access destination of the memory access for each specified instruction.

Next, the source code converting unit 104 converts the analysis preliminary information added to the analysis preliminary information-added source code 1003 into an analysis API based on the-target processor instruction executing information 1005 and outputs an analysis API-added source code 1006 in step S5. Here, the conversion of the analysis preliminary information into the analysis API is performed such that a processing time for each basic block, which is described in the target processor instruction executing information 11005 is accumulated, when the analysis API-added source code 1006 is self-compiled and is executed on the host machine. In addition, an instruction accompanying a memory access is converted so as to issue a request to the memory model 30.

FIG. 14 a diagram illustrating a specific example of the analysis API-added source code 1006. As illustrated in the figure, the first analysis preliminary information is converted into an analysis API named _PROC (first code), and an estimation value of the processing time required for processing a corresponding basic block on the target machine is passed as an argument of the analysis API. The estimation value of the processing time for each basic block is read out from the target processor instruction executing information 1005 and is used as an argument of _PROC. The basic block including the second analysis preliminary information passes an address and a size, in other words, the content of the memory access information to an analysis API named _MREAD (second code) as an argument of the analysis API and is executed so as to be converted such that a processing time required for a memory access is acquired. Here, the acquisition of an address from a symbol, for example, can be realized by using an address operator of the program language. In addition, in FIG. 14, _API2 of the first analysis preliminary information is divided into _PROC(1) and _PROC(3). Here, _PROC(1) represented in the third row represents that an lw instruction accompanying a memory access is performed in a processing time 1, In addition, _PR0C(3) represented in the fifth row is described after a process necessary for a memory access is performed by _MREAD and represents that a mov instruction and a bra instruction are performed in a processing time 3.

Next, the analysis process generating unit 105 generates a first target instruction executing analyzing process 1007 and a second target instruction executing analyzing process 1008 that are executed by being called from the analysis API in step S6. The first target instruction executing analyzing process 1007 and the second target instruction executing analyzing process 1008 configure an analysis API library 1009.

The first target instruction executing analyzing process 1007 is called from _PROC and is a process of updating the accumulated processing time for each thread which is managed by the thread scheduler 20. The first target instruction executing analyzing process 1007 inquires the thread scheduler 20 of the accumulated processing time of the thread that is currently executed, adds a processing time necessary for the target machine to the acquired accumulated processing time, and passes the added accumulated processing time to the thread scheduler 20. In other words, the first target instruction executing analyzing process 1007 adds the processing time of an executed basic block, which is calculated by the target processor instruction executing information generating unit 103, to the accumulated processing time of the thread that performs the basic block when the basic block is executed,

FIG. 15 is a diagram illustrating a specific example of the first target instruction executing analyzing process 1007. Here, the processing sequence is represented by a pseudo code. In the first target instruction executing analyzing process 1007 illustrated in FIG. 15, an accumulated processing time of the current thread is acquired in the Second row, a processing time that is passed over as an argument is added to the accumulated processing time acquired as described above in the third row, and anew accumulated processing time is set to the thread in the fourth row.

The second target instruction executing analyzing process 1008 is called from _MREAD and is a process of issuing a request for inquiring the memory model 30 of a processing time necessary for an access.

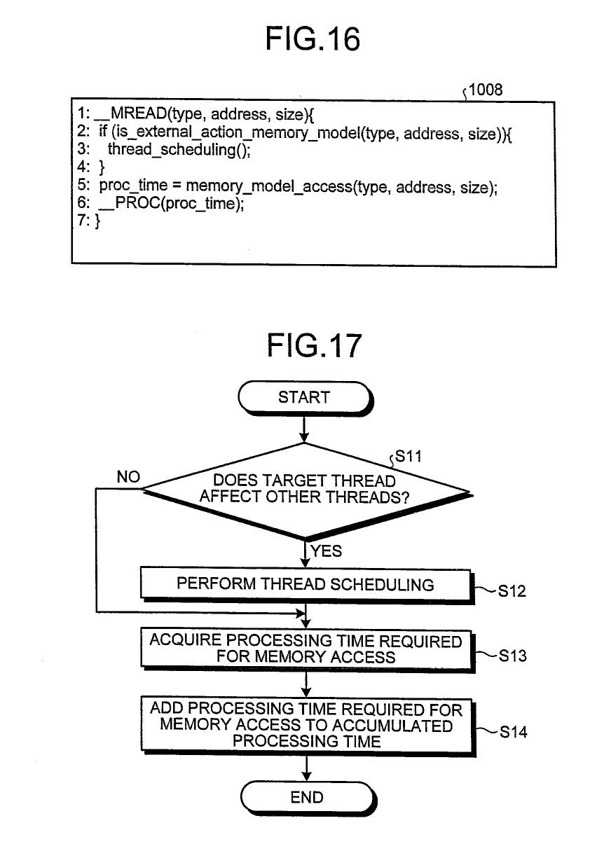

FIG. 16 is a diagram illustrating a specific example of the second target instruction executing analysing process 1008, and FIG. 17 is a flowchart illustrating the operation of the second target instruction executing analyzing process 1008. In a case where a thread having a long accumulated processing time issues a request to an individual memory model that is shared with a thread having a short accumulated processing time, the request from a further thread having the long accumulated processing time is processed first, and contradictions sequentially occur in requests issued to the shared memory model. In order to prevent this, in the second target instruction executing analyzing process 1008, first, before a memory model access request for inquiring the memory model 30 of a processing time required for an access is issued, as illustrated in the second row illustrated in FIG. 16, it is determined whether or not the thread (hereinafter, referred to as a target thread) performing the current access is outside the target processor performing the target thread, in other words, whether or not the target thread affects the other threads in step S11. More particularly, in second target instruction executing analyzing process 1008, an effect investigating request used for determining whether or not the target thread affects the other threads is issued to a memory model 30.

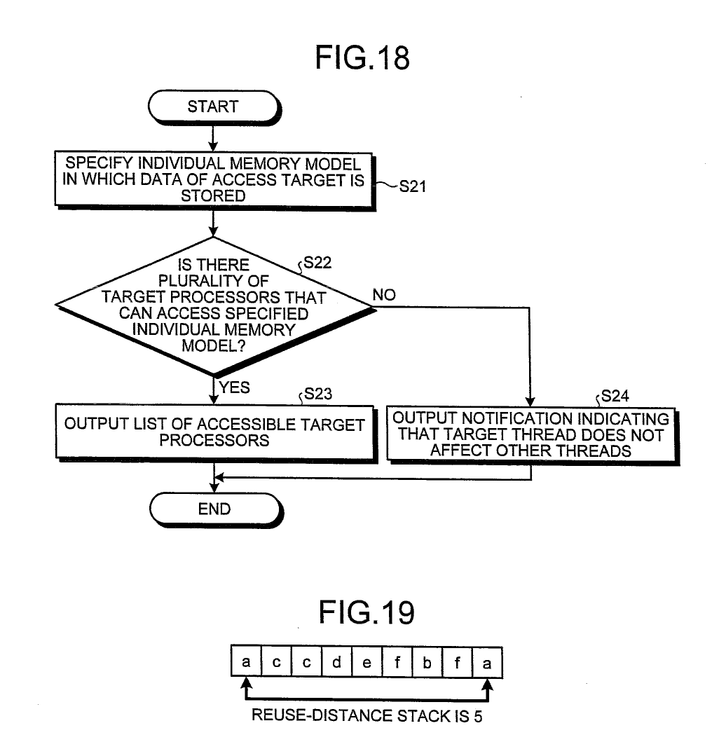

FIG. 18 is a flowchart illustrating the operation of the memory model 30 when an effect investigating request is received. When the effect investigating request is received, out of the individual memory models 30a to 30g, an individual memory model that maintains access target, data is specified in step S21, Particularly, each of the individual memory models 30a to 30g recognizes data maintained therein and searches the data maintained therein for data corresponding to the memory access information. The search is started from an individual memory model to which the target process performing the target thread is connected out of the individual memory models 30a to 30d. In a case where the individual memory model that has been searched does not maintain the corresponding data, another individual memory model connected to the main memory 5 side is searched next.

The management of data respectively maintained by the individual memory models 30a to 30g corresponding to caches may be performed, for example, by using a reuse-distance model. According to the reuse-distance model, a reuse distance stack representing a memory access sequence of each individual memory is defined, and, when there is an access to an individual memory, information (for example, a combination of an address and a size) used for identifying data of the access destination is. stacked in the reuse-distance stack of the individual memory.

FIG. 19 is a diagram illustrating a reuse-distance stack. The reuse-distance stack represents a period from a memory access for data in the past to the next memory access. In FIG. 19, information used for identifying individual data of the access destination is represented by a to f, and the reuse-distance stack is represented in a case where the sequence of the memory access is a, c, c, d, e, f, b, f, and a. In addition, the identification information represented by a to f may represent cache lines of the access destinations. In the reuse-distance stack illustrated in FIG. 19, although the counted number is “7” when the number of memory accesses from “a” for the first time to the next “a” is counted, duplicate memory accesses such as accesses to c or f are counted as one. Accordingly, the reuse distance of “a” is “5”. Here, it is assumed that the size of each of the L1 caches 2a to 2d of the target machine is x bytes, the size of each of the L2 caches 3a and 3b is y bytes, and the L1 caches and the L2 caches are fully-set associative caches. In such a case, when the reuse-distance is x or more in the L1 caches 2a to 2d, there is no access target data from the L1 caches 2a to 2d. In other words, an L1 cache miss occurs, and it is necessary to access the L2 cache to which the cache-missed L1 cache is connected. Similarly, when the reuse-distance is y or more in the L2 caches 3a and 3b, an L2 cache miss occurs, and it is necessary to access the L3 cache 4. Accordingly, by using the reuse-distance model, the date maintained by each individual memory model can be managed,

When an individual memory model maintaining the access target data is specified, the memory model 30 determines whether or not there is a plurality of target processors that can access the specified individual memory model in step S22. In a case where there is a plurality of the accessible target processors (Yes in S22), a list of the accessible target processors is output in step S23. On the other hand, in a case where there is only one accessible target processor (No in step S22), the memory model 30 outputs a notification indicating that the target thread does not affect the other threads in step S24. After step S23 or S24, the memory model 30 ends the operation performed when the effect investigating request is received.

in a case where the list of the accessible target processors is returned from the memory model 30, the target thread affect the other threads (Yes in S11), and accordingly, in the second target instruction executing analyzing process 1008, as represented in the third row illustrated in FIG. 16, thread scheduling is performed by issuing a request to the thread scheduler 20 in step S12.

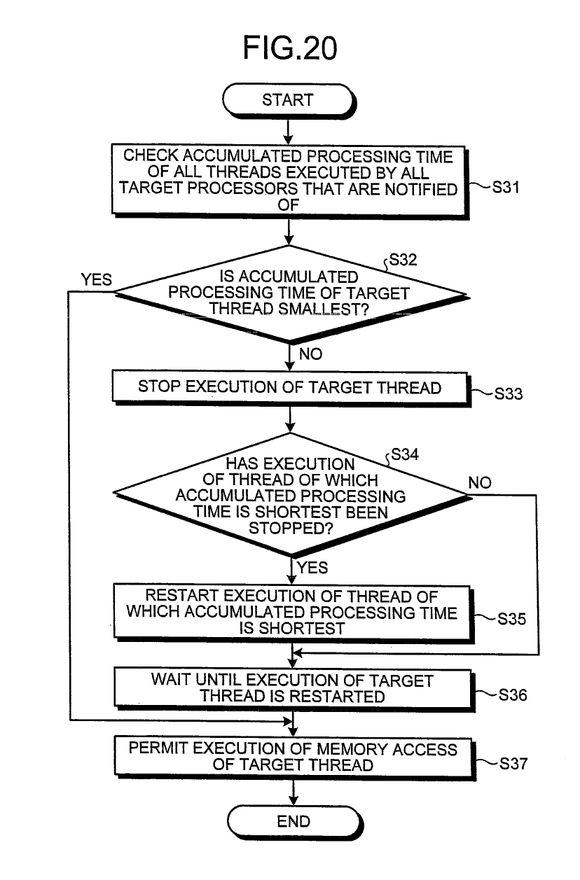

FIG. 20 is a flowchart illustrating thread scheduling. The thread scheduler 20 checks the accumulated processing times of all the threads executed by all the target processors, which are notified of in step S23, in step S31. Here, for the simplification, the thread that is executed by the target processor that is notified of in step S23 will be referred-to as a notified thread. The thread scheduler 20 determines whether or not the accumulated processing time of the target thread is the shortest of all the threads of which the accumulated processing times are notified of in step S32,

In a case where the accumulated processing time of the target thread is not the shortest (No in S32), the thread scheduler 20 stops the execution of the target thread in step S33 and determines whether or not the execution of the thread of which the accumulated processing time is the shortest is stopped in step S34. In a case where the execution of the thread of which the accumulated processing time is the smallest is stopped (Yes in S34), the thread scheduler 20 restarts the execution of the thread of which the accumulated processing time is the smallest in step S35. Then, the thread scheduler 20 waits for the restart of the execution of the target thread in step S36.

Here, in order to allow the notified thread to access the individual memory model that the target thread tries to access, the thread scheduler 20 individually performs the process of steps S31 to S35 for each of the notified threads. Accordingly, when the execution of the target thread is stopped according to the process of step S33 and is waited for the time being, by performing the process of step S31 to S35 for each notified thread out of all the notified threads and the target thread, the accumulated processing time of the target thread becomes the smallest. In the state, when one of the notified threads tries to access the individual memory model, according to the process of step S35 performed for the notified thread that tries to access the individual model, the execution of the target thread is restarted. After the execution of the target thread is restarted, the thread scheduler 20 permits the execution of the memory access of the target thread in step S37. On the other hand, in a case where the execution of the thread of which the accumulated processing time is the smallest is not stopped (No in step S34), the thread scheduler 20 skips the process of step S35.

In a case where the accumulated processing time of the target thread is the shortest of all the threads notified of in step S23 (Yes in S32), the execution of the memory access of the target thread is permitted in step S37, and the operation ends.

As above, the thread scheduler 20 performs scheduling of the target thread and the other threads that are affected such that the accumulated processing time of the target thread Side is shorter than that of the other threads that apply affects.

Here, the execution of the target thread is described to be restarted according to the process of step S35 for the other notified thread. However, instead of the process of steps S34 to S36, it may be configured to determine whether or not the accumulated processing time of the target thread is the shortest. In a case where the accumulated processing time of the target thread is the shortest, the execution of the target thread may be restarted. In addition, in a case where the accumulated processing time of the target thread is not the smallest, it is determined again whether or not the accumulated processing time of the target thread is the smallest.

After the scheduling is performed, the second target instruction executing analyzing process 1008 issues a memory access request to the memory model 30 and acquires the processing time required to access the individual memory model of the access destination in step S13.

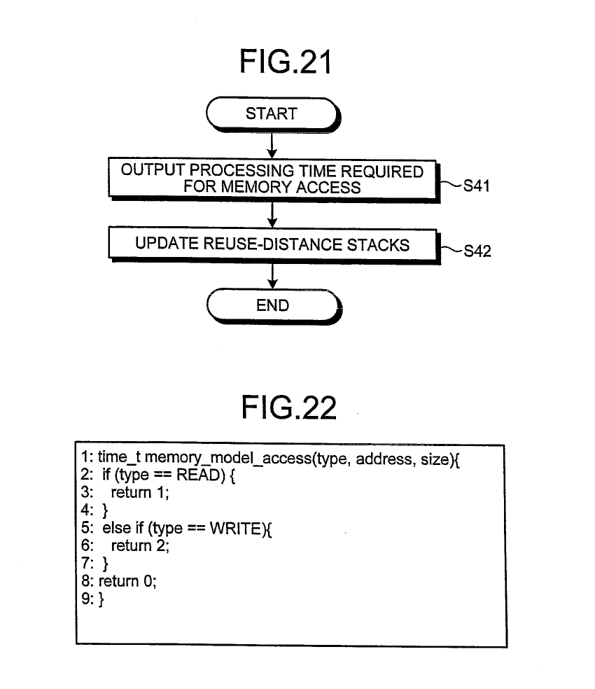

FIG. 21 is a flowchart illustrating the operation of the memory model 30 when a memory access request is received. When the memory access request is received, the memory model 30 calculates the processing time required for a memory access based on the individual memory access model specified in step S21 and outputs the calculated processing time in step S41. Then, in step S42, the memory model 30 updates the reuse-distance stacks of all the individual memory models that have been searched in the process of step S21 and ends the operation.

As above, in-the second target instruction executing analyzing process 1008, when the basic block performing a memory access is executed, scheduling between the thread executing the basic block that performs the memory access and the thread having the same access destination is performed based on the memory access information, the processing time required for the memory access of the basic block performing the memory access is calculated, and the calculated processing time required for the memory access is added to the accumulated processing time of the thread executing the basic block that performs the memory access.

Thereafter, in the second target instruction executing analyzing process 1008, the first target instruction executing analyzing process 1007 is called, the processing time required for the memory access, which is output in step S41, is added to the accumulated processing time in step S14, and the operation ends. In a case where the target thread does not affect the other threads (No in step S11), in the second target instruction executing analyzing process 1008, the process of step S12 is skipped.

Here, the reuse-distance model is described to be used so as to determine a cache hit/miss by using the memory model 30 or so as to calculate the processing time required for a memory access. However, the method of calculating the processing time required for a memory access is not limited thereto. For example, in a case where read can be processed in one cycle, and write can be processed in two cycles in terms of the number of cycles of the target processor for any access, by performing a process as illustrated in FIG. 22, the processing time required for the memory access can be acquired.

After the process of S5, the self-compiling unit 106 performs self-compiling the analysis API-added source code 1006, links the analysis API library in the process of the self-compiling, and outputs the performance estimating program 1001 in S6.

A user can acquire an estimation value 1002 of the processing time when the target program acquired by performing cross-compiling the input source code 1000 by using the target processor by executing the performance estimating program 1001 in a host machine to which the thread scheduler 20 and the memory model 30 are installed in S7. The performance estimating program 1001 estimates the accumulated processing time of the thread that is executed last time and outputs the estimated accumulated processing time as a value 1002 by being executed in the host machine to which the thread scheduler 20 and the memory model 30 are installed.

In addition, in the description presented above, although the analysis preliminary information has been described as a description for calling the functional-type API, any description may be used as long as it is in the form that can be interpreted by the cross-compiling unit 102 and the source code converting unit 104.

Furthermore, the analysis API library D10 may be prepared in advance,

As described above, according to the first embodiment of the present invention, the cross-compiling unit 102 classifies and generates an instruction string for a target machine for each basic block by performing cross-compiling of the source code (input source code 1000) of the software that has the computer including a plurality of target processors 1a to 1d and a memory group (the L1 caches 2a to 2d, the L2 caches 3a and 3b, the L3 cache 4, and the main memory 5) that the plurality of target processors 1a to 1d accesses as a target machine, specifies instructions, which are included in the generated instruction string, performing a memory access, the target processor instruction executing information generating unit 103 calculates the processing time required for the process not affecting the outside of the target processors 1a to 1d for each basic block based on the instruction string, which is generated as described above, for each basic block and generates the memory access information used for identifying the access destination of the memory access for each specified instruction, and the source code converting unit 104 inserts _PROC that is a code adding the processing time of the executed basic block, which is calculated by the processing time calculating unit, to the accumulated processing time of thread that executes the basic block when the basic block is executed into a place corresponding to the input source code 1000, scheduling between the thread executing the basic block that performs a memory access when the basic block performing the memory access is executed and the thread having the same access destination is performed based on the memory access information, the processing time required for a memory access of the basic block that performs the memory access is calculated, _MREAD that is a code that adds the processing time required for the memory access, which is calculated as described above, to the accumulated processing time of the thread executing the basic block that perform the memory access is inserted into a place corresponding to the input source code 1000, the self-compiling unit 106 performs self-compiling of the source code (the analysis API-added source code 1006) after the insertion of the code and generates a performance estimating program 1001 that outputs the accumulated processing time of the thread that has been completed the last, similarly configured, whereby the processing time of the software can be estimated without preparing the target machine. Since the processing time of the software can be estimated without preparing a target machine, and the performance evaluation of the software can be performed even in a case where the target machine is in the designing process, whereby the operation of estimating the processing time when software developed only for the multiprocessors is executed can be efficiently performed.

In addition, the evaluation of the performance of the software may be considered to be performed based on the performance ratio between the host machine and the target machine (Comparative Example 1). However, in Comparative Example 1, a difference in the execution time based on the difference in the architecture of the host machine and the target machine is not considered, and accordingly, in a case where the execution time is markedly different from each other based on the difference in the architecture, there is a problem in that the precision markedly decreases. In contrast to this, according to the first embodiment, the performance estimating program 1001 can calculate the processing time when the software is executed by the target machine with the memory architecture or the processor architecture being considered, whereby the processing time of the software dedicated to the target machine can be estimated more precisely than Comparative Example 1.

Furthermore, while a method (Comparative Example 2) of performing the evaluation of software dedicated to the target machine by using an instruction simulator mounted by software may be considered, the performance estimating program 1001 calculates the processing time in a target machine based on instructions generated through cross-compiling, and accordingly, an instruction executed by the target processor is not simulated, whereby the processing time of software dedicated to the target machine can be estimated at a speed higher than that of Comparative Example 2.

In addition, the host machine further includes the thread scheduler 20 that manages the accumulated processing time for each thread executed by processors included in the target machine, and the first target instruction executing analyzing process 1007 called by _PROC calls the thread scheduler 20 while Using the processing time calculated by the target processor instruction executing information generating unit 103 as an argument, and the processing time passed as the argument is configured to be added to the accumulated processing time of the executed thread, whereby a user, can change the thread scheduler 20 in accordance with the architecture of the target processors 1a to 1d.

Furthermore, the memory group included in the target machine includes a plurality of individual memories (the L1 caches 2a to 2d, the L2 caches 3a and 3b, the L3 cache 4, and the main memory 5) that form a hierarchical structure,, and, in the second target instruction executing analysing process 1008 called by _MREAD, while a plurality of threads having the same individual memory of the access destination is configured as the threads having the same access destination, it may be configured such that the individual memories are divided into a plurality of areas, and the threads having the same areas that are divided so as to be generated as the same access destinations are configured as the threads having the same access destinations.

In addition, the thread scheduler 20 allows a memory access performed by the basic block that performs the memory access until the accumulated processing time is the shortest among a plurality of threads having the same individual memory of the access destination to be waited and returns the waiting time, and accordingly, in the second target instruction executing analyzing process 1008 called by _MREAD, it is configured such that the thread scheduler 20 is called, and the waiting time returned from the called thread scheduler 20 is added to the accumulated processing time of the executed thread, whereby a contradiction that a future process affects the past process can be prevented.

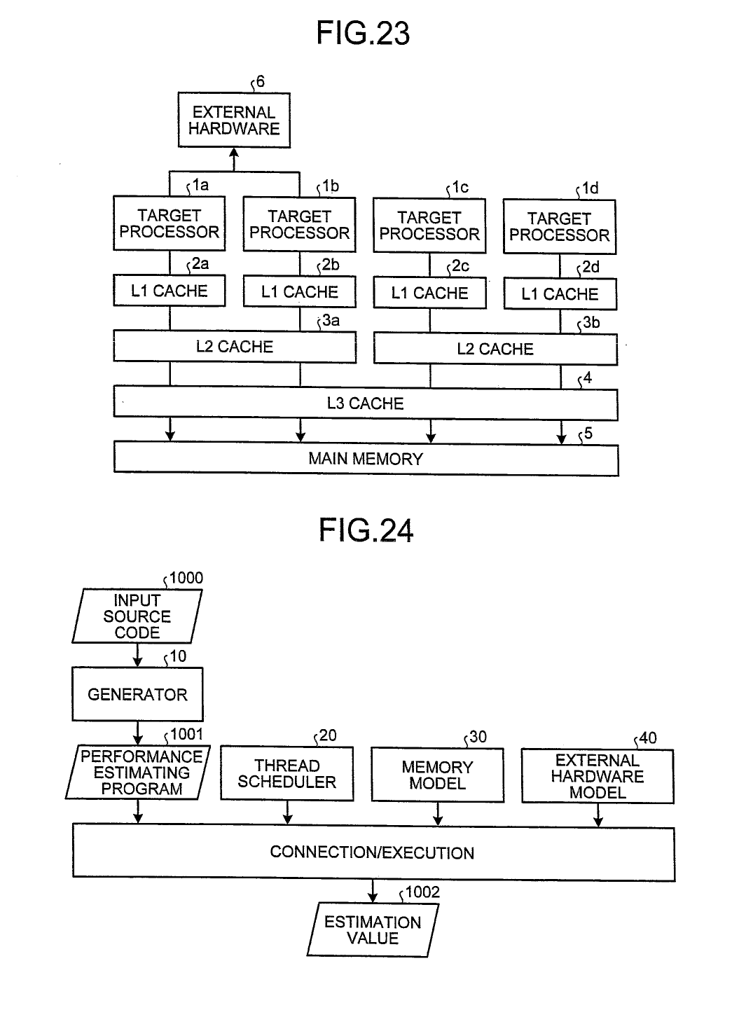

FIG. 23 is a diagram illustrating another configuration example of a target machine. In a second embodiment, a case will be described in which the performance of an input source code targeted for a machine illustrated in FIG. 23 is estimated. The same reference numeral is assigned to the same element as that described in the first embodiment, and a duplicate description, will not be presented.

The target machine illustrated in FIG. 23 has a configuration acquired by adding external hardware 6 to the target machine illustrated in FIG. 1. The external hardware 6 is connected to be common to (shared by) a target processor la and a target processor 1b. The external hardware 6 is a device other than target processors 1a to 1d and individual memories, and, when the target processor 1a or the target processor 1b executes an instruction used for driving the external hardware 6, the external hardware 6 performs a predetermined process. Here, to execute the instruction used for driving the external hardware 6 on the target processors 1a to 1d is referred to as kicking the external hardware 6. In addition, in a case where the target processor 1c or the target processor 1d that is not connected to the external hardware 6 kicks the external hardware, the external hardware 6 does not perform a predetermined process so as to be in an erroneous state.

FIG. 24 is a conceptual diagram illustrating the appearance of calculating the processing time of the target machine illustrated in FIG. 23. The generator 10 generates the performance estimating program 1001 based on the input source code 1000. In the second embodiment, the performance estimating program 1001 is executed by a host machine that includes the scheduler 20, the memory model 30, and an external hardware model 40 and generates and outputs an estimation value 1002.

The external hardware model 40 is acquired by modeling the external hardware 6 and has a function of returning a processing time that is necessary for performing the process by using the external hardware 6 in terms of the number of cycles of the target processor in a case where an instruction used for driving the external hardware 6 is executed on the target processor.

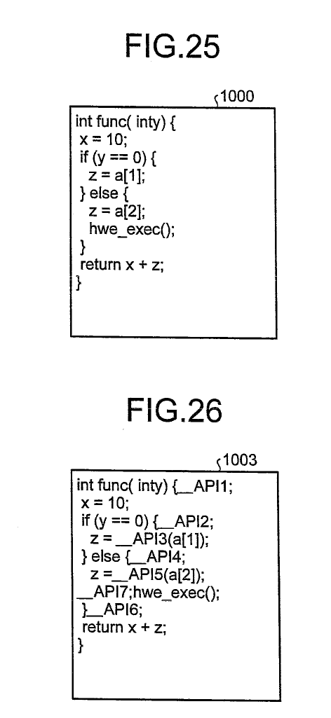

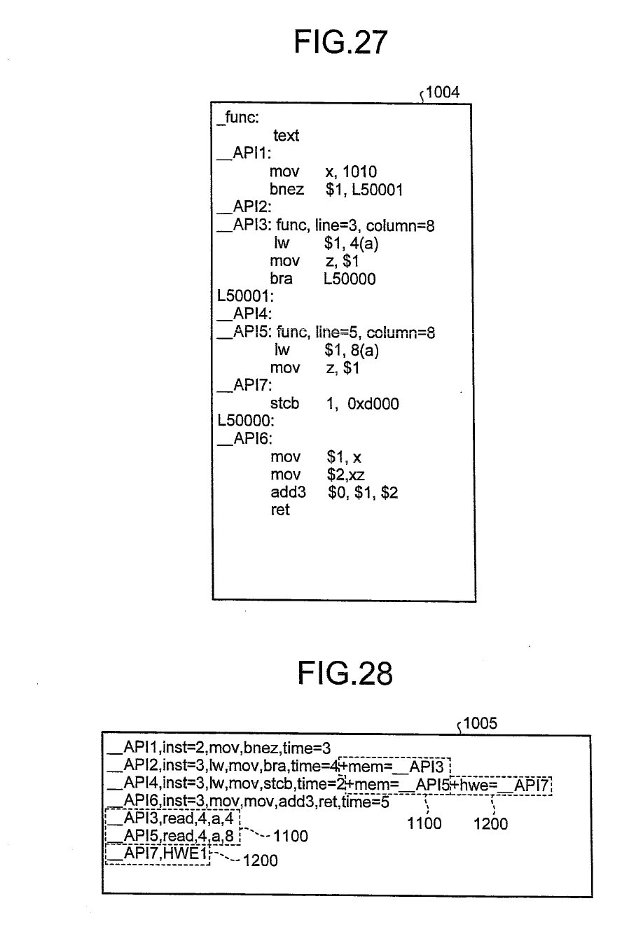

FIG. 25 is a diagram illustrating a specific example of the input source code 1000, FIG. 26 is a diagram illustrating a specific example of the analysis preliminary information-added source code 1003, and FIG. 27 is a diagram illustrating a specific example of the target processor instruction string 1004. As illustrated in FIG. 25, the input source code 1000 according to the second, embodiment is acquired by adding a code row “hwe_exec( )” that kicks the external hardware 6 in the seventh row of the example of the input source code 1000, which is illustrated in FIG. 7, described in the first embodiment. According to the analysis preliminary information-added source code 1003 illustrated in FIG. 26, _API7 is inserted in the code row in which “hwe_exec ( )” is described as the second analysis preliminary information. In other words, in the second embodiment, the process of kicking the external hardware 6 is also included in the process affecting the outside of the target processors 1a to 1d. In addition, according to the target processor instruction string 1004 illustrated in FIG. 27, in a basic block represented by _API4, an stcb instruction is executed in addition to the lw instruction and the mov instruction. The stcb instruction is an instruction for kicking the external hardware in accordance with the first argument and the second argument. In other words, in the second embodiment, the cross-compiling unit 102 specifies instructions, which are included in the generated instruction string, used for driving the external hardware 6.

FIG. 28 is a diagram illustrating a specific example of target processor instruction executing information 1005. Like _API4, in a case where an instruction used for a memory access and an instruction for kicking the external hardware model 40 are accompanied in the instruction, the processing time is acquired by adding a time necessary for an access to the memory group and a processing time that is necessary when the external hardware 6 is kicked to a time required to process instructions. In the target processor instruction executing information 1005, external hardware access information represented in a description 1200 is included in addition to the memory access information represented in the description 1100. In the seventh row, it is represented that the name of the external hardware 6 corresponding to _API7 is “HWE1”. In other words, in the second embodiment, the target processor instruction executing information generating unit 103 generates external hardware access information used for identifying an instruction used for driving the specified external hardware 6 based on the specified instruction that is used for driving the external hardware 6.

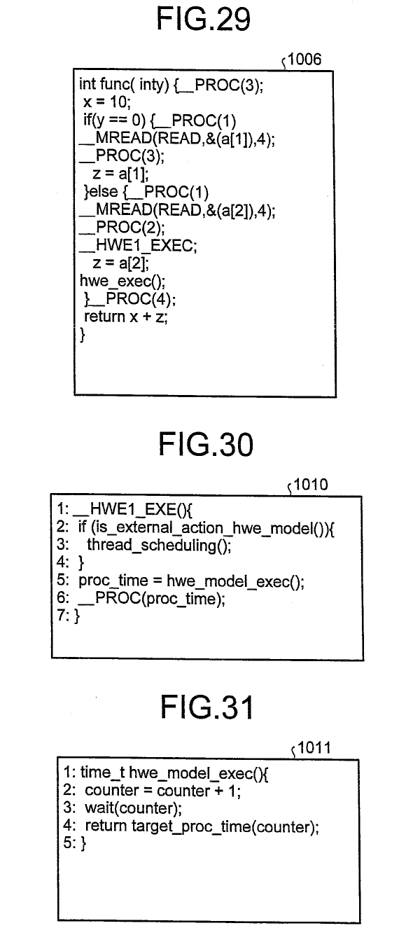

FIG. 29 is a diagram illustrating a specific example of the analysis API-added source code 1006. According to the analysis API-added source code 1006 illustrated in FIG. 29, in a case where the basic block includes an instruction for kicking the external hardware 6, an analysis API named _HWE1_EXEC (third code) is inserted into the basic block. Here, _PROC of the basic block that is represented by _API4 is divided into _PROC(1) and _PROC(2). The _PROC(1) appearing first represents that an lw instruction accompanying a memory access is performed in a processing time 1. Here, _MREAD performs a process that is necessary for a memory access. In addition, _PROC(2) represents that a mov instruction and a stcb instruction are performed in a processing time 2.

The analysis process generating unit 105, in addition to the first target instruction executing analyzing process 1007 and the second target instruction executing analyzing process 1008, generates a third target instruction executing analyzing process that is called by HWE1_EXEC and generates an analysis API library 1009 by combining the first-target instruction executing analyzing process 1007, the second target instruction executing analyzing process 1008, and a third, target instruction executing analyzing process 1010.

FIG. 30 is a diagram illustrating a specific example of the third target instruction executing analyzing process 1010. In this figure, the third target instruction executing analyzing process 1010 is represented by a pseudo code, in the third target instruction executing analyzing process 1010, it is checked whether or not the target, thread affects the other threads by kicking the external hardware model 40 in the second row. Here, since the target processor la and the target processor 1b are connected to the external hardware 6 together, for example/ in a case where the target thread is performed by the target processor 1a, the thread performed by the target processor 1b is affected by the target thread. In the third target instruction executing analyzing process 1010, in a case where the target thread affects the other threads, the thread scheduler 20 is called in the third row, and scheduling of the target thread and the threads affected by the target thread is performed. In the third target instruction executing analyzing process 1010, in a case where the target thread does not affect the other threads, or the thread scheduling is completed by calling the thread scheduler 20, as represented in the fifth row, the external hardware model 40 is executed so as to acquire a time that is necessary for the processing Of the external hardware 6.

FIG. 31 is a diagram illustrating a specific example of the process (external hardware model executing process) when the external hardware model 40 is executed. Also in this figure, art external hardware model executing process 1011 is represented by a pseudo code. In addition, in the external hardware model executing process 1011 illustrated in this figure, it is assumed that a process of waiting for a time corresponding to the number of times of driving is performed as an example. In the external hardware model executing process 1011, a process of counting the number of times of driving is performed (in the second row), and the process of waiting for a time corresponding to the number of times of driving is performed (in the third row). Then, in the external hardware model executing process 1011, a processing time in terms of the number of cycles of the target processor is output (in the fourth row).

In the third target instruction executing analyzing process 1010, a process of adding the time output by the external hardware model executing process 1011 to the accumulated processing time of the target thread is performed (the sixth row in FIG. 30),

As above, in the second embodiment, the source code converting unit 104 inserts the third target instruction executing analyzing process 1010, in which the processing time required to drive the external hardware 6 when this basic block driving the external hardware 6 is executed is added to the accumulated processing time of the thread that executes the basic block driving the external hardware 6, to a corresponding place in the input source code 1000.

As described above, according to the second embodiment of the present invention, it is configured such that the target machine includes the external hardware 6 that is driven by the target processors 1a and 1b, the cross-compiling unit 102 specifies instructions, which are included in the generated instruction string, used for driving the external hardware 6, the target processor instruction executing information generating unit 103 generates the external hardware access information used for identifying specified instructions used for driving the external hardware 6 based on the specified instructions that drive the external hardware 6, and the source code converting unit 104 inserts the third target instruction executing analysing process 1010, in which the processing time required to drive the external hardware 6 when the basic block driving the external hardware 6 is executed to the accumulated processing time of the thread executing the basic block that drives the external hardware 6, into a corresponding place in the input source code 1000, and accordingly, even in a case where the target machine includes the external hardware 6, the performance estimating program 1001 that can estimate the performance of the software dedicated to the target machine can be generated.

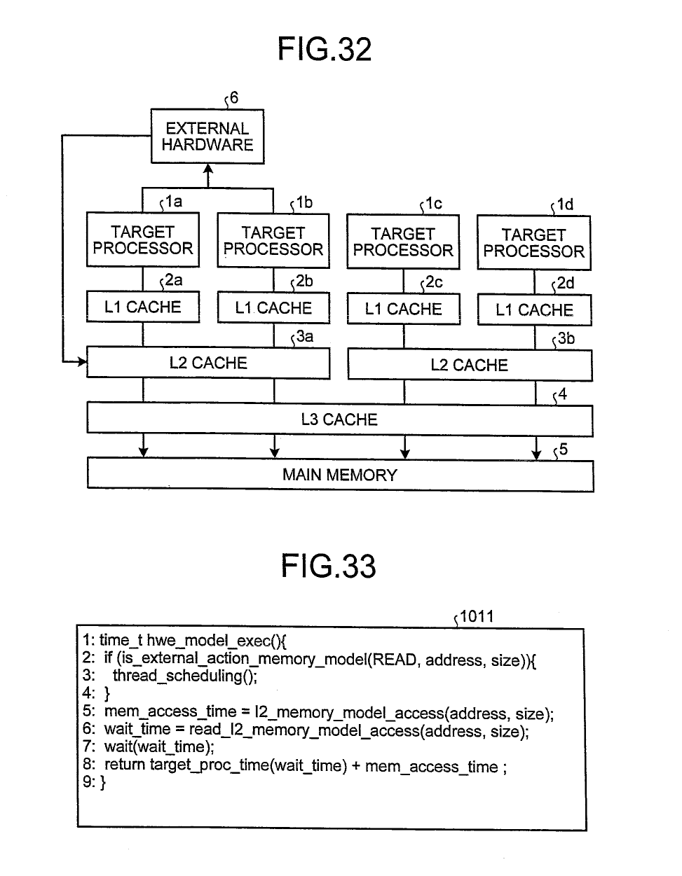

In a third embodiment, a case will be described in which the external hardware 6 is connected to a memory. In the example illustrated in FIG. 32, the external hardware 6 is connected to the L2 cache 3a.

In a case where the external hardware 6 is connected to the individual memory, the external hardware model executing process 1011 is performed as illustrated in FIG. 33. In the external hardware model executing process 1011 illustrated in FIG. 33, it is checked whether or not a memory access from the external hardware model 40 affects threads other than the thread that kicks the external hardware model 40 (in the second row). Here, the thread that kicks the external hardware model 40 is referred to as a target thread. In a case where the target thread affects the other threads, in the external hardware model executing process 1011, the thread scheduler 20 is called, and scheduling of threads is performed (in the third row). In a case where the target thread does not affect the other threads, or the thread scheduling is completed by calling the thread scheduler 20, in the external hardware model executing process 1011, a request is issued to the memory model 30 (in the fifth row), and a time required for the memory access and the data value stored at the address are acquired (in the sixth row). Then, a process of waiting for a time corresponding to the acquired data value is performed (in the seventh row). Thereafter, the waited time and the time required for the memory access are output (in the eighth row).

In other words, in the third target instruction executing analyzing process 1010, a processing time required for a memory access from the external hardware 6 is calculated by performing scheduling between the external hardware 6 and the threads having the same access destination, and the processing time, which is calculated as described above, required for the memory access from the external hardware 6 and the processing time required to drive the external hardware 6 are added to the accumulated processing time of the thread that executes the basic block driving the external hardware 6. Accordingly, even in a case where the external hardware 6 performs a memory access, the software dedicated to the target machine can be evaluated.

As described above, according to the first to third embodiments, the processing time of software can be estimated without preparing a target machine, and the processing time of the software can be estimated with precision higher than that of a case where an instruction simulation is performed. Accordingly, an operation of estimating the processing time when software developed so as to be dedicated to multiprocessors is executed can be efficiently performed.

In addition, it may be configured such that the analysis process generating unit 105 receives the target processor instruction executing information 1005 of the first to third embodiments as an input and generates necessary processes out of the first target instruction executing analyzing process 1007, the second target instruction executing analyzing process 1008, and the third target instruction executing analyzing process 1010.

While certain embodiments have been described, these embodiments have been presented by way of example only, and are not intended to limit the scope of the inventions, Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A program generating apparatus comprising;
a cross-compiling unit that generates an instruction string for each basic block by performing cross-compiling of a source code of software and specifies instructions, which are included in the instruction string, performing a memory access;
a processing time calculating unit that calculates a processing time required for executing the instruction string for each basic block and generates a memory access information, which identifies access destination of the memory access, for each of the specified instructions;
a source code converting unit that inserts a first code, which adds the processing time of the basic block to an accumulated processing time variable of an executed thread of the basic block, and a second code, which calculates a processing time required for the memory access based on the memory access information and adds the calculated processing time required for the memory access to an accumulated processing time variable of an executed thread of the memory access, into the source code; and
a self-compiling unit that generates, by performing self-compiling of the source code after the insertion of the codes, a performance estimating program outputting the accumulated processing time variable of the thread executed last time.

2. The program generating apparatus according to claim 1, wherein the source code of the software is virtually executed on a target machine that includes a plurality of processors and a memory that the plurality of processors accesses.

3. The program generating apparatus according to claim 2,
wherein the target machine includes external hardware that is driven by the processors,
wherein the cross-compiling unit specifies instructions which are included in the generated instruction string and drives the external hardware,
wherein the processing time calculating unit generates an external hardware access information that identifies the specified instruction driving the external hardware, and
wherein the source code converting unit inserts a third code that adds a processing time required for driving the external hardware to an accumulated processing time variable of an executed thread of the instruction used for driving the external hardware into the source code based on the external hardware access information.

4. The program generating apparatus according to claim 3,
wherein the external hardware accesses the memory, and
wherein the third code further adds a processing time required for the memory access of the external hardware to the accumulated processing time of the executed thread of the instruction that drives the external hardware.

5. The program generating apparatus according to claim 2, further comprising
a thread scheduler that performs a first processing in which an accumulated processing time for each thread executed by the processors included in the target machine is managed,
wherein the first code starts up the first processing by using the thread scheduler while using the processing time of the basic block as an argument.

6. The program generating apparatus according to claim 5, further comprising
a memory model that specifies an individual memory of an access destination based on the memory access information and determines whether or not there is a plurality of the processors that can access the specified individual memory,
wherein the second code calls the memory model while using the memory access information as an argument.

7. The program generating apparatus according to claim 6,
wherein the thread scheduler performs a second processing in which a waiting time is calculated for each thread executed by the plurality of processors that can access the specified individual memory, and
wherein in a case where it is determined that there is a plurality of the processors that can access the specified individual memory, the memory model called by the second code starts up the second processing, calculates a waiting time of the executed thread of the memory access, and calculates the processing time required for the memory access based on the calculated waiting time.

8. A method of generating a program, the method comprising:
generating an instruction string for each basic block by performing cross-compiling of a source code of software;
specifying instructions, which are included in the instruction string, performing a memory access;
calculating a processing time required for executing the instruction string for each basic block;
generating a memory access information, which identifies an access destination of the memory access, for each of the specified instructions;
inserting a first code, which adds the processing time of the basic block to an accumulated processing time variable of an executed thread of the basic block, and a second code, which calculates the processing time required for the memory access based on the memory access information and adds the calculated processing time required for the memory access to the accumulated processing time variable of an executed thread of the memory access, into the source code; and
generating, by performing self-compiling of the source code after the insertion of the codes, a performance estimating program outputting the accumulated processing time variable of the thread executed last time.

9. The method of generating a program according to claim 8, wherein the source code of the software is virtually executed on a target machine that includes a plurality of processors and a memory that the plurality of processors accesses.

10. The method of generating a program according to claim 9,
wherein the target machine includes external hardware that is driven by the processors,
the method further comprising:
specifying instructions, which are included in the generated instruction string, used for driving the external hardware;
generating an external hardware access information that identifies the specified instruction used for driving the external hardware; and
inserting a third code that adds a processing time required for driving the external hardware to an accumulated processing time variable of an executed thread of the instruction used for driving the external hardware into the source code based on the external hardware access information.

11. The method of generating a program according to claim 10,
wherein the external hardware accesses the memory, and
wherein the third code is a code that further adds a processing time required for the memory access of the external hardware to the accumulated processing time of the executed thread of the instruction that drives the external hardware.

12. The method of generating a program according to claim 9, wherein the first code is a code that starts up a first processing in which an accumulated processing time for each thread executed by the processors included in the target machine is managed while using the processing time of the basic block as an argument.

13. The method of generating a program according to claim 12, wherein the second code is a code that calls a memory model that specifies an individual memory of an access destination based on an argument with memory access information required for the memory access being used as the argument and determines whether or not there is a plurality of the processors that can access the specified individual memory.

14. The method of generating a program according to claim 13, wherein the memory model called by the second code, in a case where it is determined that there is a plurality of the processors that can access the specified individual memory, calculates a waiting time of the executed thread of the memory access by performing a second processing in which a waiting time is calculated for each thread executed by the plurality of processors that can access the specified individual memory and calculates the processing time required for the memory access based on the calculated waiting time.

15. A non-transitory computer readable medium comprising instructions that cause a computer to:
generate an instruction string for each basic block by performing cross-compiling of a source code of software; specify instructions, which are included in the instruction string, performing a memory access;
calculate a processing time required for executing the instruction string for each basic block;
generate a memory access information, which identifies an access destination of the memory access, for each of the specified instructions;
insert a first code, which adds the processing time of the basic block to an accumulated processing time variable of an executed thread of the basic block, and a second code, which calculates the processing time required for the memory access based on the memory access information and adds the calculated processing time required for the memory access to an accumulated processing time variable of an executed thread of the memory access, into the source code; and
generate a performance estimating program outputting the accumulated processing time variable of the thread executed last time by performing self-compiling of the source code after the insertion of the codes.

16. The medium according to claim 15, wherein the source code of the software is virtually executed on a target machine that includes a plurality of processors and a memory that the plurality of processors accesses,

17. The medium according to claim 16,
wherein the target machine includes external hardware that is driven by the processors, and
wherein the instructions further cause the computer to:
specify instructions, which are included in the generated instruction string, used for driving the external hardware;
generate an external hardware access information that identifies the specified instruction used for driving the external hardware; and
insert a third code that adds a processing time required for driving the external hardware to an accumulated processing time variable of an executed thread of the instruction used for driving the external hardware into the source code based on the external hardware access information.

18. The medium according to claim 17,
wherein the external hardware accesses the memory, and
wherein the third code is a code that further adds a processing time required for the memory access of the external hardware to an accumulated processing time of the executed thread of the instruction that drives the external hardware.

19. The medium according to claim 16, wherein the first code is a code that starts up a first processing in which an accumulated processing time for each thread executed by the processors included in the target machine is managed while using the processing time of the basic block as an argument.

20. The medium according to claim 19, wherein the second code is a code that calls a memory model that specifies an individual memory of an access destination based on an argument with memory access information required for the memory access being used as the argument and determines whether or not there is a plurality of the processors that can access the specified individual memory.
